(19) United States
(12) Patent Application Publication
(10) Pub. No.: US 2013/0163963 A1
(43) Pub. Date: Jun. 27, 2013

(54) SYSTEM AND METHOD FOR GENERATING MUSIC VIDEOS FROM SYNCHRONIZED USER-VIDEO RECORDED CONTENT

(71) Applicants: Cory Crosland, New York, NY (US); Marcel Esser, Arlington, VA (US); Michael Fiedel, New York, NY (US); Mehul Patel, New York, NY (US)

(72) Inventors: Cory Crosland, New York, NY (US); Marcel Esser, Arlington, VA (US); Michael Fiedel, New York, NY (US); Mehul Patel, New York, NY (US)

(21) Appl. No.: 13/333,321

(22) Filed: Dec. 21, 2011

(51) Int. Cl. G11B 27/02; H04N 5/93

(52) U.S. Cl. 386/285; 386/E05.028

(57) ABSTRACT

A method for automatically generating a master music video comprising a plurality of user-generated videos synchronized against a segment of an audio track. The method includes dividing an audio track into a plurality of segments. A user-recorded video is automatically selected for each of the plurality of segments, where each selected user-recorded video includes a video recording of a user synchronized against an audio clip of a unique one of the plurality of segments. The method further includes concatenating the user-recorded videos in a sequence and into a master music video featuring the user-recorded videos all placed in synch against the entire audio track such that playback of the plurality of segments associated with the user-recorded videos in the sequence corresponds to an original sequence of the audio track in its entirety.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention described herein generally relates to systems, methods and computer program products that allows users to record and synchronize a short video clip against a segment of an audio track for insertion into a master music video comprised of a plurality of short video clips in synch against an entire audio track.

### BACKGROUND OF THE INVENTION

A lip dub is a type of video that combines lip synching and audio dubbing to create a music video. The video is made by filming individuals or a group of people lip synching to a song or any recorded audio and dubbing over it with the original audio of the song. These videos have become popular with the advent of mass participatory video hosting and sharing services such as YouTube. Video hosting or sharing services allows individuals to upload video clips to an Internet website. The video host will then store the videos on its server, and allow others to view these videos.

Individual lip dub videos are a growing trend, where each of these videos has a potential of generating millions of views. However, video hosting and sharing services only allow for users to create and share individual clips. Thus, there is a need for allowing users to record short lip dub clips that can be seamlessly inserted into a single music video that features multiple clips from users around the world. There is also a lack of features for sharing and voting on individual clips to generate both an interactive and competitive online stage.

### SUMMARY OF THE INVENTION

The present invention provides a method and system for generating a music video comprising a plurality of user-generated videos synchronized against a segment of an audio track. The method includes dividing an audio track into a plurality of segments. A user-recorded video is selected for each of the plurality of segments, where each selected user-recorded video includes a video recording of a user and an audio clip of a unique one of the plurality of segments. The method further includes a system for automating the playback of user-recorded videos in a master music video that joins the video clips, each synchronized with a given audio track segment, in synch against the entire audio track, or in a sequence so that, in their entirety, they correspond to an original sequence of the audio track.

According to one embodiment, selecting the user-recorded video for each of the plurality of segments includes selecting user-recorded video with the highest ratings for each of the plurality of segments. The method may include receiving one or more ratings for the user-recorded videos. In addition to the foregoing, the user-recorded videos may be shared via social networking sites. Furthermore, the method may also include receiving the user-recorded video from the user. Accordingly, the user-recorded video may include a video recording of the user performing lip-synching with an audio clip of a given one of the plurality of segments.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a computing system according to an embodiment of the present invention;

FIG. 2 illustrates a flowchart of a method for recording a video clip according to an embodiment of the present invention;

FIG. 3A illustrates a flowchart of a method for generating a music video according to an embodiment of the present invention;

FIG. 3B illustrates a visualization of the generation of a music video comprising user-recorded videos according to an embodiment of the present invention;

FIG. 4A illustrates a flowchart of a method for generating a music video in real time according to an embodiment of the present invention;

FIG. 4B illustrates the concatenation and synchronization of user-generated music videos to an audio track according to an embodiment of the present invention;

FIG. 4C illustrates a visualization of the generation of a music video from a plurality of possible video clips for a given section of an overall music video according to an embodiment of the present invention; and

FIG. 5 through FIG. 9 illustrate exemplary screen shots of a video sharing platform according to an embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

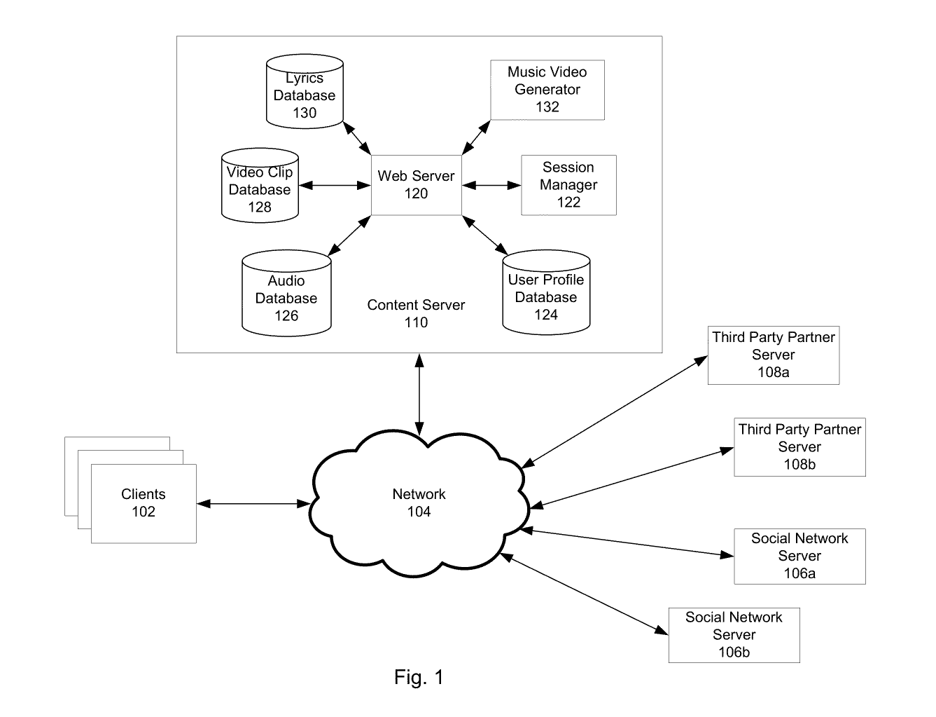

FIG. 1 illustrates a computing system according to an embodiment of the present invention. The system illustrated in FIG. 1 includes clients 102, network 104, social network server 106a, 106b, third party server 108a, 108b, and content server 110. Each of clients 102 and servers 106a-b, 108a-b, and 110 may comprise a desktop personal computer, workstation, terminal, laptop, personal digital assistant (PDA), cell phone, or any computing device capable of connecting to a network. Clients 102 may also comprise a graphical user interface (GUI) or a browser application provided on a display (e.g., monitor screen, LCD or LED display, projector, etc.). Users may use clients 102 to request recording of a video clip on content server 110. The recording of the video clip may be associated with an audio track. Requests may be received by content server 110 from clients 102 via network 104.

Network 104 may be any suitable type of network allowing transport of data communications across thereof. In one embodiment, the network may be the Internet, following known Internet protocols for data communication, or any other communication network, e.g., any local area network (LAN), or wide area network (WAN) connection. Content server 110 includes web server 120, session manager 122, user profile database 124, audio database 126, video clip database 128, lyrics database 130, and music video generator 132. Communications and requests from clients 102 may be received by web server 120. Web server 120 may host a web site or computing environment to provide content and services that can be accessed through network 104.

Web server 120 is operable to provide a platform that allows users to record lip dub or singing video clips of themselves in coordination with a provided audio clip or lyrics. The web server 120 may generate web pages embedded with recording functionality or a third party recording application such as Microsoft's Windows Media Player and Flash. A user may request to record a video clip of the user performing to an audio track that is available in audio database 126. The audio track may be selected by the user, content server 110, or randomly determined. According to one embodiment, the selected audio track is retrieved from audio database 126 and divided into a plurality of segments.

One of the plurality of audio track segments may be selected by content server 110 and assigned to the requesting user for video recording. In another embodiment, the user may be allowed to select one or more of the plurality of audio track segments for video recording. The audio track may be divided into substantially equal segments based on the total duration of the audio track. Alternatively, the audio track may be divided into segments based on the timing of the lyrics and chorus in the audio track. In other embodiments, the audio track may also be divided into segments defined by the user or content server 110.

Lyrics corresponding to the selected audio track may be retrieved from lyrics database 130. The lyrics may be provided to assist the user in performing to the audio track segment(s). The selected audio track segment(s) and the corresponding lyrics may be provided to the user on a web page. The web page may include a media player interface and controls for recording a video clip. The media player interface allows a user to play or preview the selected audio track segment(s). Lyrics corresponding to the playing audio track segment(s) are displayed in karaoke or semi-karaoke fashion, and may be navigated either manually or automatically, in conjunction with the playing audio track segment(s).

The user may select to start recording a video clip that corresponds to the audio track segment(s), or the user may decide to select another audio track segment to record to. Client 102 also includes at least one device to record a video such as a web camera. During the recording, the user may sing, lip-sync, dance, or perform any other activity that does not necessarily require the user to sing to the audio track segment(s). The video recording may include the user's performance recorded with an audio clip of the selected audio track segment.

Once a video recording of the user is completed, the video clip recording may be stored in video clip database 128. Video clip database 128 may store video clip recordings from users for a plurality of audio tracks and audio track segments. Each video clip recording includes a recorded video associated with a selected audio track segment. However, in some embodiments, a user may record or upload a video clip recording for an entire track and content server 110 may divide the video clip recording up into segments based on the audio track segments or based on user-rating and other browsing options.

Prior to storage in video clip database 128, video clip recordings may be analyzed for quality control purposes and inappropriate content. Video clip recordings that may contain content unsuitable for public sharing can be filtered out and discarded. Users may also create user profile accounts and associate their video clip recordings to their user profiles. User profiles are stored in user profile database 124. For users with existing user profiles, a user may log in at anytime during the recording session, which is managed by session manager 122. Session manager 122 authenticates and manages user profiles and recording sessions. When users are logged in recorded video clips may be automatically associated with their user profiles.

Users may also share their recorded video clips on various social networking sites such as Facebook and Twitter. Videos stored in video clip database 128 may be transmitted to social network servers 106a and 106b, where each video clip is given a unique URL. The unique URL may be used to share and search for individual clips that are associated with a user subscribed to the various social networking sites. Video clip recordings may be shared to receive votes or ratings from other users on social networking sites. In one embodiment, professional recording artists may also use social network sites to promote their albums or tracks through third party servers 108a, 108b, or content server 110. For example, the artist Katy Perry may promote her album, “Teenage Dream” by sharing or sponsoring a music video of the track “E.T.” from the album using user-recorded video clips according to the embodiments of the present invention. In another embodiment, the professional recording artist can upload their own web camera clips to generate a music video including partially or entirely of the artist's clips based on an algorithm that automatically sets the appropriate ratio and location of video clips by the professional recording artist.

Content server 110 may generate music videos using music video generator 132. Music video generator 132 may receive a request for the generation of a music video for a given audio track. Video clip recordings from user participants associated with the given audio track are retrieved from video clip database 128. Video clip database 128 may store a plurality of video clips for each audio track segment of the given audio track. Each of the plurality of video clips includes user-generated videos that are synchronized against a segment of a given audio track. A given video clip may be selected for each audio track segment for a given audio track requested for music video creation.

For each audio track segment, there will be a number of unique video clips which allows a master music video to select a clip each time the video is played. Video clips may be selected based on one or more criteria. The one or more criteria may include highest rated, most viewed, newest, etc at the time the music video is being generated. In another embodiment, the video clips may be randomly selected for each audio track segment. Once a video clip recording has been selected for each audio track segment, the video clip recordings may be concatenated, merged, or connected in chronological sequence corresponding to the audio track. Concatenation of the video clip recordings results in a master music video joining the video clips, each synchronized with a given audio track segment, in synch with the entire audio track, or in a sequence such that playback of the video clips of the user-recorded videos correspond to an original sequence of the audio track in its entirety. In another embodiment, each video clip may be inserted into a music video template at the appropriate section or segment of the audio track. As such, the generated music video includes a plurality of video clip recordings of different users played in sync over the original audio track.

Requests for music videos may be received from content server 110, or from a third party partner server such as 108a. Third party partner server 108a may provide interactive user-generated-content to users. In one embodiment, clients 102 may send requests to record video clips via third part partner server 108a, which forwards those requests to content server 110. Video clip recordings may also be shared on third party server 108a to receive votes and ranking. Other third party partner servers such as 108b may be sponsors, or music label partners of content server 110 who provide a wide variety of recording artist and audio tracks for users to choose from to record and purchase. Visitors are able to click a link, for example, either Amazon or iTunes to purchase the original soundtrack. Third party server 108b may provide audio tracks and lyrics to audio database 126 and lyrics database 130. Sponsors may offer prizes and giveaways for top ranked video clip recordings to further motivate users to participate and share their videos.

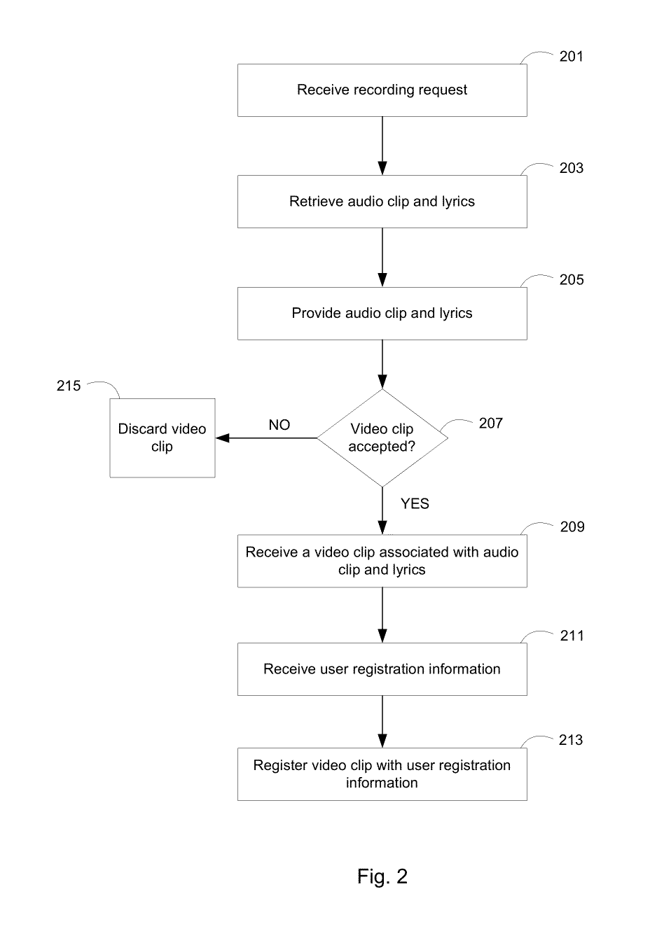

FIG. 2 illustrates a flowchart of a method for recording a video clip according to an embodiment of the present invention. Users may contribute or participate in generating a music video by recording a video clip of himself or herself lip-syncing to or performing an audio track segment or clip. A recording request is received from a user, step 201. The request may include an identification of a given track. The audio track may be divided up into a plurality of segments or clips where one of the clips may be assigned to the user. Each audio clip includes a particular portion or duration of the audio track.

The audio clip and lyrics corresponding to the audio clip are retrieved, step 203. Lyrics retrieved for the audio clip may include a portion of the lyrics to the audio track specific to the audio clip. The audio clip and lyrics are provided to the user, step 205. The audio clip may be provided to the user on a web page embedded with a media interface which also includes a video recording functionality. The user may be allowed to listen to the clip before recording and corresponding lyrics for the clip may be displayed next to the media interface. A user may also select a different clip should they want to record a different section of the audio track.

Users may create a video via a web camera recording of themselves or a group lip-synching to the audio clip. A record button on the media interface may be selected and a countdown timer may start before the audio clip and video recording begin. While the audio plays, the web page may also include the retrieved lyrics the user can view to perform for their audio clip. In another embodiment, instead of recording using the media interface on the web page, a user may instead upload a video clip file for the audio clip. In one embodiment, the video clips are recorded with the audio clip dubbed over the video. After a complete recording or upload, the user may be prompted to preview their video clip including music and video playback. The user may decide to either accept the video recording or reject it.

A decision is received as to whether the user has accepted or rejected a recorded video clip, step 207. If the user decides to reject the video clip recording, the video clip is discarded, step 215. Otherwise, a video clip associated with the audio clip and lyrics is received from the user, step 209. The video clip may be subjected to approval and content standards prior to acceptance of the video clip. Upon receiving the video clip, the user may be prompted to provide user information, credentials, or to create a user profile. User registration information is received, step 211. User information may include a username, date of birth, password, and email address. The received user registration information is used to register the video clip to the user, step 213. A verification email may be sent to the user's email address where an active email address may be required to receive clip approval.

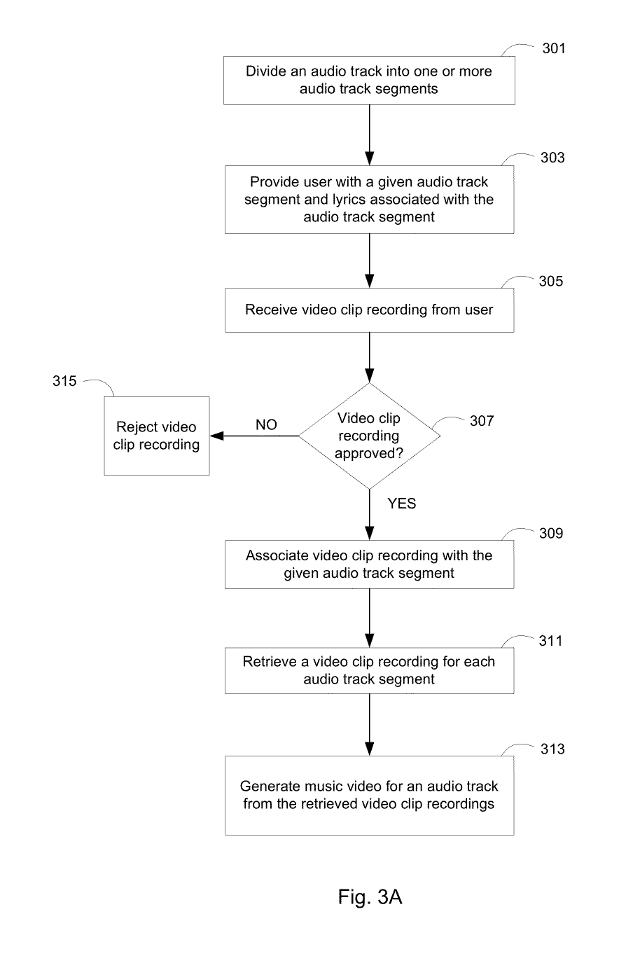

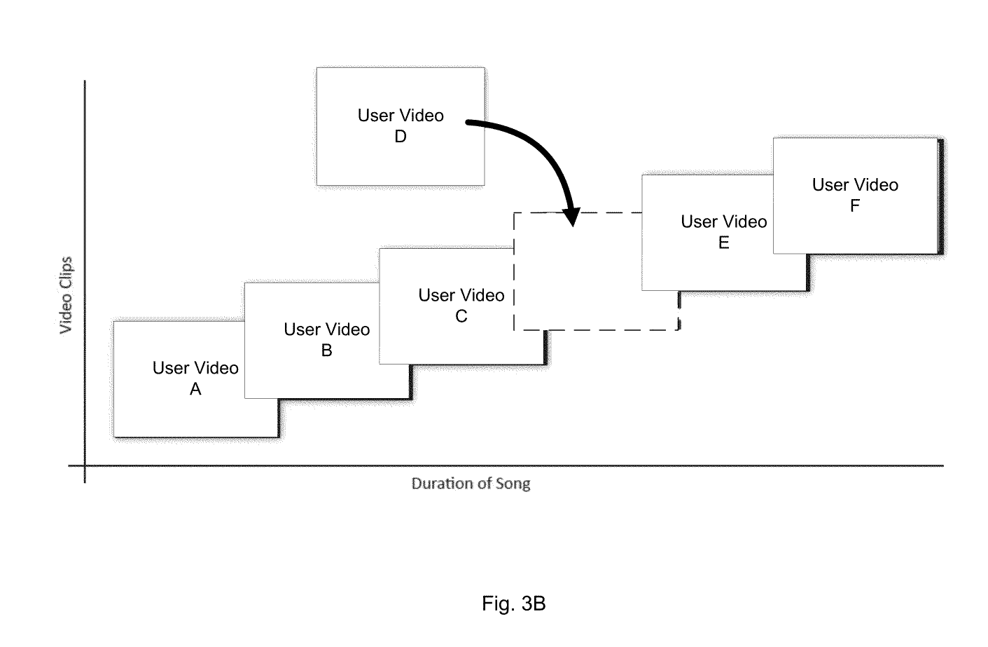

FIG. 3A illustrates a flowchart of a method for generating a music video according to an embodiment of the present invention. An audio track is divided into one or more audio track segments, step 301. The audio track may be broken into, for example, equal-length audio track segments. A user is provided with a given audio track segment and lyrics associated with the audio track segment, step 303. Users may be given an audio clip of a particular audio track segment to lip-synch or record. The particular track may be selected based on existing video clips submitted for the audio track, a need for video clip recordings for particular track segments, randomly selected, or selected by the user. A video clip can be recorded by the user using the audio clip and associated lyrics. The video recorded by the user may then be synchronized with the audio clip of the audio track segment.

A video clip recording is received from the user, step 305. The video clip recording received from the user is subject to approval by an administrator. If the video clip recording does not meet the standards of the administrator and is not approved, the video clip recording is rejected, step 315. Otherwise, the video clip recording is associated with the given audio track segment, step 309. The video clip recording may be indexed or tagged with an identifier of the given audio track segment.

A music video may be generated using a plurality of video clip recordings received from users. As such, a video clip recording is retrieved for each audio track segment, step 311. For example, FIG. 3B depicts a plurality of user videos A through F, which may be selected in a particular sequence for a duration of a song. Each of the video clip recordings retrieved may be selected, for example, according to the highest ranked video clip for each respective audio track segment. A music video is generated for an audio track from the retrieved video clip recordings, step 313. The retrieved video clip recordings may be concatenated or merged into a single master video clip to create the music video.

A given video clip may include an audio clip segment dubbed over and synchronized with a user-recording. The video clips are inserted into a music video at the appropriate section in real time, where the music video is composed of multiple video clips, one after another, each in sync with the audio. The resulting music video may be a series of lip dubbed user-recorded videos, each synchronized with a given audio track segment, played in sequence such that playback of the video clips of the user-recorded videos correspond to an original sequence of the audio track in its entirety.

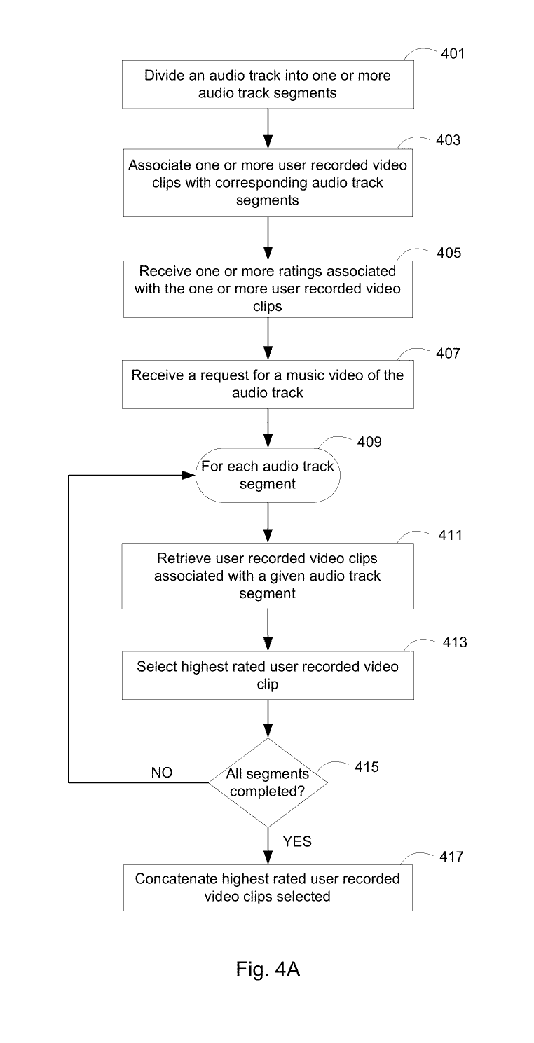

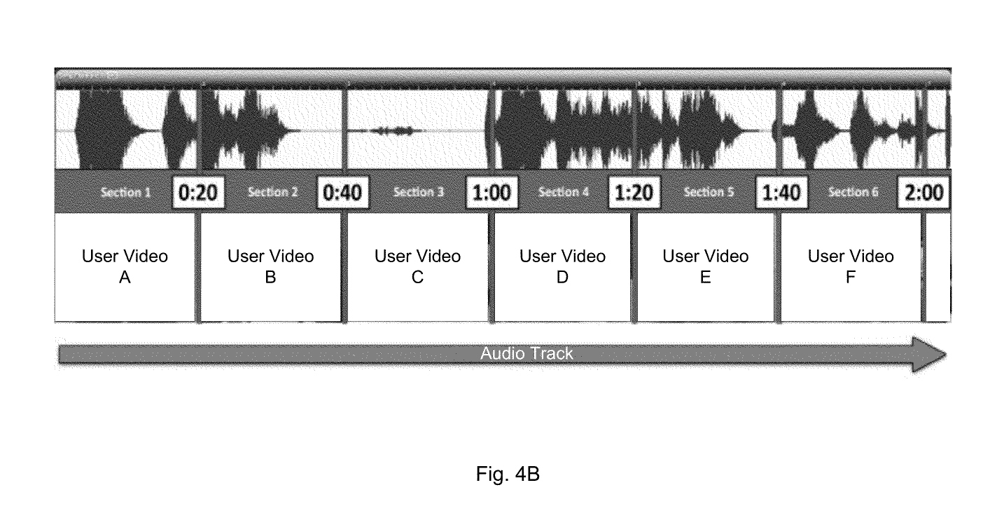

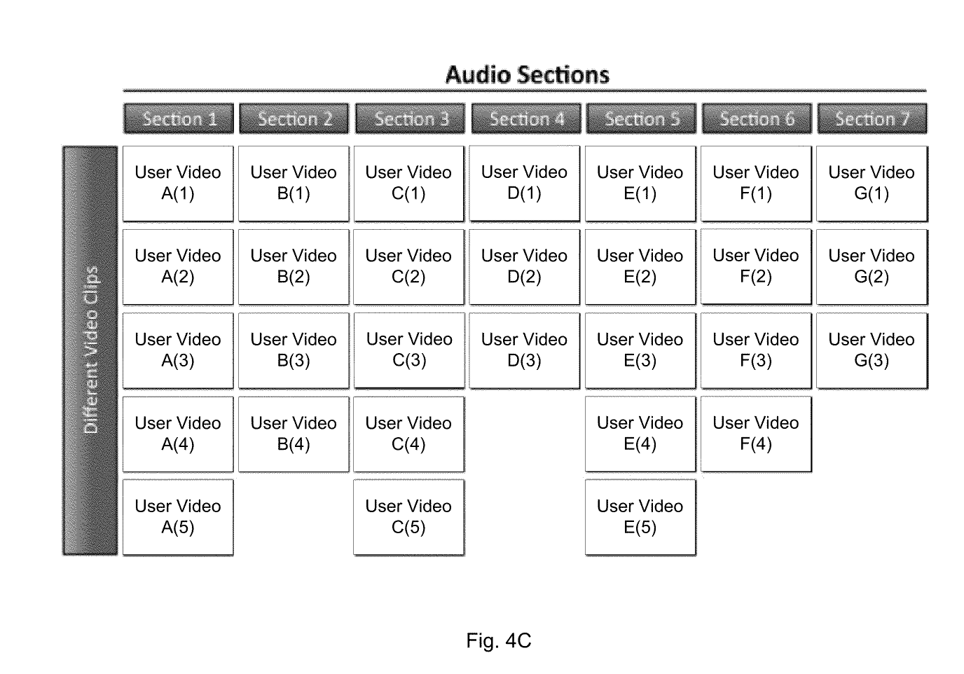

FIG. 4A illustrates a flowchart of a method for generating a music video in real time according to an embodiment of the present invention. An audio track is divided into one or more audio track segments, step 401. Each audio track segment represents a portion or a sample of an audio track. FIG. 4B provides as a visualization of this process by illustrating a plurality of segments or sections, corresponding to the duration of an audio track. Each of Sections 1 through 6 are associated with a given subset or period of the audio track. In this particular example, each section has a period of 20 seconds. In a next step 403, one or more user recorded video clips are associated with corresponding audio track segments. Each of the one or more user recorded video clips includes user-video content recorded, which may be synchronized with an audio clip of a specific audio track segment (e.g., a lip dub). Recorded video clips corresponding to the audio track segments are received and may be shared with a plurality of users across the world by, for example, the Internet. Sharing may be performed using video services such as YouTube, or by means of social networking sites such as Facebook or Twitter.

One or more ratings associated with the one or more user recorded video clips are received, step 405. Ratings may include indicators of like or dislike, thumbs up or thumbs down, points, scale, percentage, etc. In step 407, a request for a music video of the audio track is received. The request may be received from a user desiring to view a music video of user-generated content associated with the audio track. A music video may be generated dynamically in real time upon each request.

According to an embodiment of the present invention, the music video is comprised of a plurality of user-recorded videos merged together in sequence based on their associated audio track segments they are recorded to. In generating the music video each audio track segment of the audio track is processed or iterated, step 409. For a given audio track segment, user recorded video clips associated with a given audio track segment are retrieved, step 411. Each segment for the given audio track may have a plurality of candidate user video clips to be selected from for placement in each audio track section, as illustrated in FIG. 4B. For each of User Video slots A through F, one of a plurality of available user videos (different video clips) may be selected for a given slot (Sections 1 through 7) in the master music video.

In a next step 413, the highest rated user recorded video clip is selected from the retrieved user recorded video clips associated with the given audio track segment. Each of the selected recorded video clips may be added into a respective audio track segment slot in the master music video. User videos A through F shown in FIG. 4C may be the highest ranking user videos selected for association with each section of the audio track. User videos selected and placed into each section “slot” may also be selected based on other criteria. In other embodiments, the criteria include at least one of number or votes, ratings, popularity, views, randomly selected, etc.

A determination is made whether selection of user recorded video clips for all of the audio track segments has been completed, step 415. Steps 409 through 413 are repeated if user recorded video clips have not been selected for all of the audio track segments. Otherwise, all of the highest rated user recorded video clips selected are concatenated, step 417. Concatenation of the user recorded video clips generates a music video comprised of a plurality of lip-dub videos that are joined, each synchronized against a segment of an audio track, such that when played, features the user-recorded videos played in synch with the original sequence of the entire audio track.

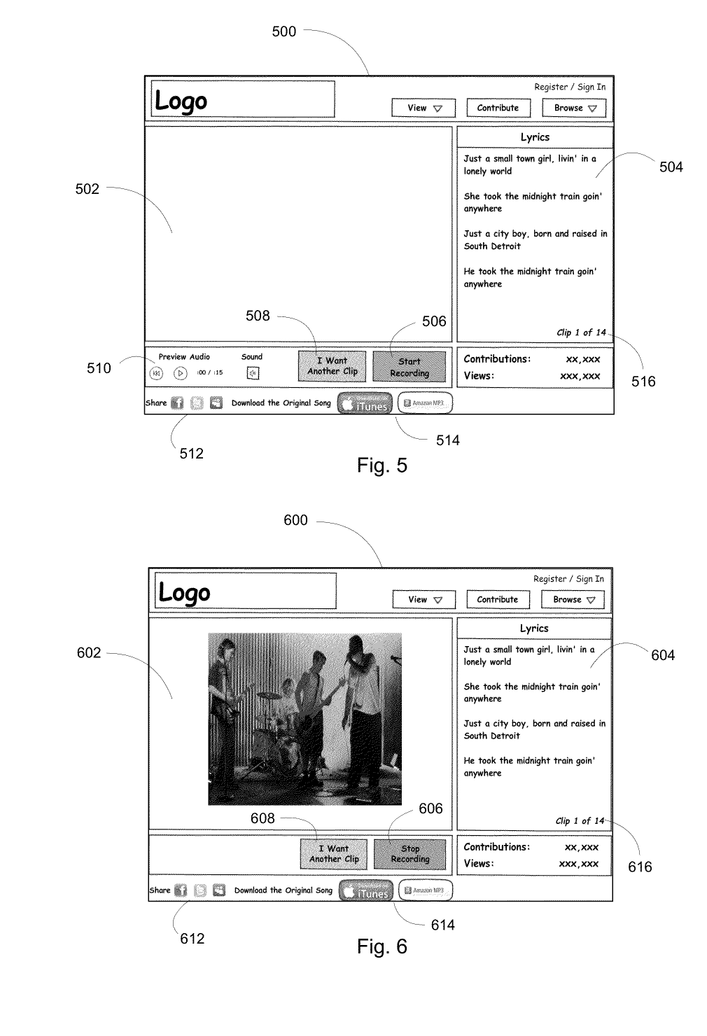

FIG. 5 illustrates an exemplary illustration of a video sharing interface during an audio clip preview according to an embodiment of the present invention. The interface illustrated in FIG. 5 includes an interface 500 comprising display section 502, lyrics section 504, a start recording button 506, an another clip button 508, media interface 510, share buttons 512, song download buttons 514, and clip indicator 516. Display section 502 is displayed as a blank to indicate that there is not recording activity. A user may preview an audio clip of an audio track segment prior to video recording. Media interface 510 provides functionality for playback of the audio clip. During playback of the audio clip, lyrics corresponding to the audio clip are displayed in lyrics section 504.

A user desiring to view or record another audio clip may select button 508. Clip indicator 516 displays the currently selected clip out of a total number of clips. In this example, the user is viewing clip 1 out of 14 clips. Start recording button 506 may be selected by the user to start a video recording of the clip currently being viewed. Selection of button 506 may initiate communications with the user's web camera and start a video recording. Share buttons 512 may include one or more icons such as Facebook, Twitter, and MySpace. The share buttons 512 allow the user to share a video clip to be recorded on interface 500 to various social networking sites. Users will also have an opportunity to purchase and download the original soundtrack using song download buttons 514. The song download buttons may include online music retailers such as Amazon and iTunes.

FIG. 6 illustrates an exemplary illustration of a video sharing interface during video recording according to an embodiment of the present invention. The interface illustrated in FIG. 6 includes an interface 600, display section 602, lyrics section 604, stop recording button 606, another clip button 608, share buttons 612, song download buttons 614, and clip indicator 616. Interface 600 shows an exemplary interface of a user recording a video for an audio clip. Display screen 602 provides feedback of the content that is being recorded so users can see themselves performing. In the current recording session, clip 1 is being performed to, as indicated by clip indicator 616. During recording, the audio clip plays for the recording users to lip-synch.

As during the preview of the audio clip, the lyrics corresponding to the audio clip are again displayed in lyrics section 604. Stop recording button 606 allows users to stop recording if they'd like to stop and start over. Another button 608 allows a user to stop recording and select another clip. The share buttons 612 allow the user to share a video clip being recorded on interface 600 to various social networking sites. Users will also have an opportunity to purchase and download the original soundtrack using song download buttons 614.

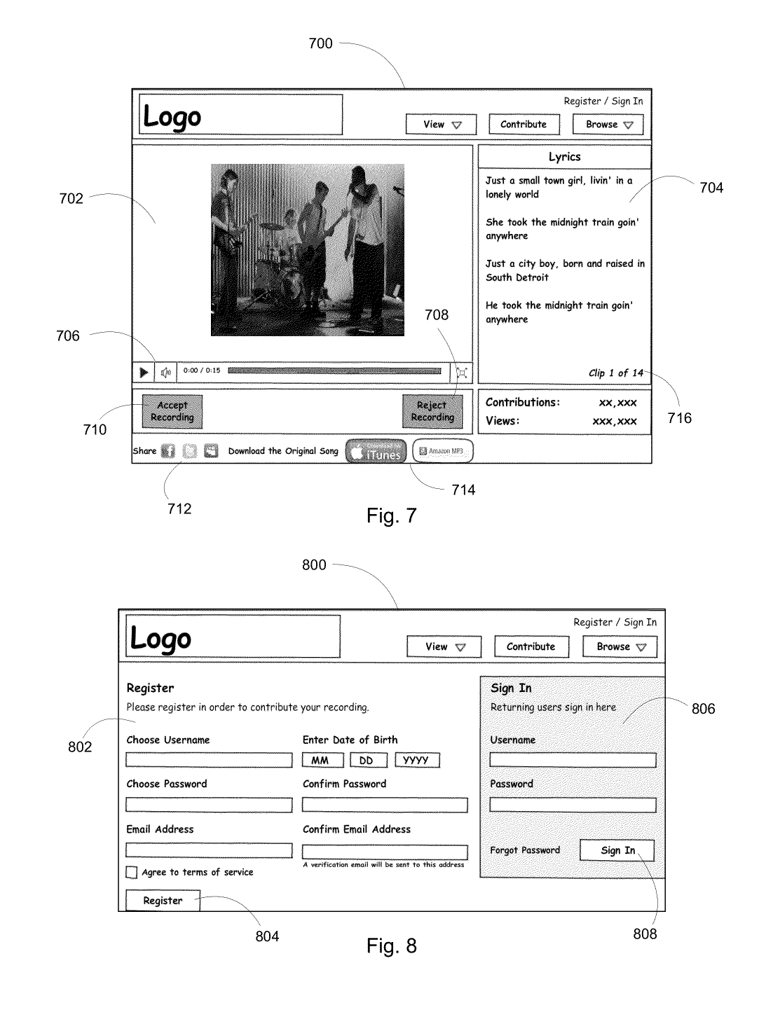

FIG. 7 illustrates an exemplary illustration of a video sharing interface during a preview of a user video recording according to an embodiment of the present invention. The interface illustrated in FIG. 7 includes an interface 700, display section 702, lyrics section 704, media interface 706, reject recording button 708, accept recording button 710, share buttons 712, song download buttons 714, and clip indicator 716. Media interface 706 may be used to control playback of a user video recording on display section 702 performed for clip 1 with the displayed lyrics in lyrics section 704. On interface 700, a user may either reject the recording by selecting “reject recording” button 708 or accept the recording by selecting the “accept recording” button 710. A rejected recording will be discarded and accepted recordings may be saved.

After accepting a recorded clip, the user may be prompted to register the recorded video with a screen such as the one illustrated in FIG. 8. The registration interface 800 of FIG. 8 includes user information fields 802, register button 804, sign in fields 806, and sign in button 808. For returning users, or users who already have a registered user profile, they may fill in sign in fields 806 and sign in with button 808. New users may be required to fill in user information fields 802, which include username, password, date of birth, a valid email address. When information fields 802 have been completed the user may submit the information by selecting register button 804 to register for a new user profile or account. A verification email may be sent to the registered email who then must confirm their email address in order to have their video recording approved.

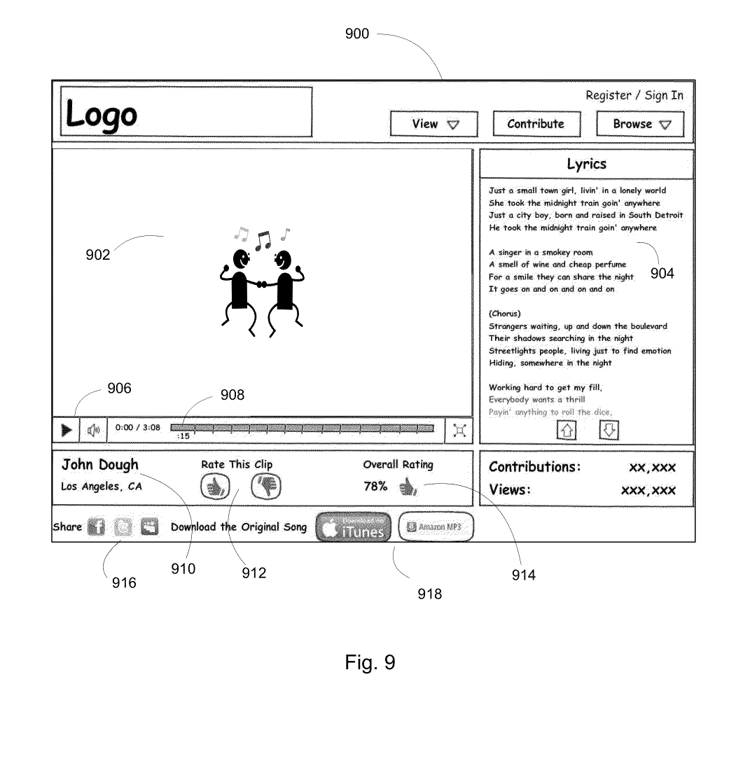

FIG. 9. Illustrates an exemplary illustration of a video sharing interface for viewing user-recorded clips according an embodiment of the present invention. The interface 900 illustrated in FIG. 9 includes display section 902, lyrics section 904, media interface 906, audio track segment indicator 908, recording user information 910, rating input 912, overall rating indicator 914, share buttons 916, and download buttons 918. Visitors can browse individual clips of other contributor as well as rate each one. While viewing a video on display section 902, visitors can rate each clip with rating input 912 by selecting either a “thumbs up” or a “thumbs down” and manually scroll the lyrics at lyrics section 904. Media interface 906 may be used to control playback of the video. Track segment indicator 908 indicates which particular audio track segment the video created by the user indicated by recording user information 910 is being played. Overall rating indicator 914 displays the overall ratings received by the video from other users.

FIGS. 1 through 9 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for generating a music video, the method comprising:
dividing an audio track into a plurality of segments;
automatically selecting a user-recorded video for each of the plurality of segments, each selected user-recorded video including a video recording of a user synchronized against an audio clip of a unique one of the plurality of segments; and
concatenating the user-recorded videos into a music video in a sequence corresponding to the overall audio track such that playback of the plurality of segments associated with the user-recorded videos in the sequence corresponds to an original sequence of the audio track.

2. The method of claim 1 wherein selecting the user-recorded video for each of the plurality of segments includes selecting user-recorded video with the highest ratings for each of the plurality of segments.

3. The method of claim 1 further comprising receiving one or more ratings for the user-recorded videos.

4. The method of claim 1 further comprising sharing the user-recorded videos via social networking sites.

5. The method of claim 1 further comprising receiving the user-recorded video from the user.

6. The method of claim 1 wherein the user-recorded video includes a video recording of the user performing lip-synching with an audio clip of a given one of the plurality of segments.

7. A system for generating a music video, the system comprising:
a memory device having executable instructions stored therein; and
a processing device, in response to the executable instructions, operative to:
divide an audio track into a plurality of segments;
select a user-recorded video for each of the plurality of segments, each selected user-recorded video including a video recording of a user and an audio clip of a unique one of the plurality of segments; and
concatenate the user-recorded videos into a music video in a sequence corresponding to the overall audio track such that playback of the plurality of segments associated with the user-recorded videos in the sequence corresponds to an original sequence of the audio track.

8. The system of claim 7 wherein selecting the user-recorded video for each of the plurality of segments includes selecting user-recorded video with the highest ratings for each of the plurality of segments.

9. The system of claim 7 wherein the processor is further operative to receive one or more ratings for the user-recorded videos.

10. The system of claim 7 wherein the processor is further operative to share the user-recorded videos via social networking sites.

11. The system of claim 7 wherein the processor is further operative to receive the user-recorded video from the user.

12. The system of claim 7 wherein the user-recorded video includes a video recording of the user performing lip-synching with an audio clip of a given one of the plurality of segments.

13. Non-transitory computer readable media comprising program code that when executed by a programmable processor causes execution of a method for generating a music video, the computer readable media comprising:
computer program code for dividing an audio track into a plurality of segments;
computer program code for selecting a user-recorded video for each of the plurality of segments, each selected user-recorded video including a video recording of a user and an audio clip of a unique one of the plurality of segments; and
computer program code for concatenating the user-recorded videos into a music video in a sequence corresponding to the overall audio track such that playback of the plurality of segments associated with the user-recorded videos in the sequence corresponds to an original sequence of the audio track.

14. The computer readable media of claim 13 wherein the computer program code for selecting the user-recorded video for each of the plurality of segments includes computer program code for selecting user-recorded video with the highest ratings for each of the plurality of segments.

15. The computer readable media of claim 13 further comprising computer program code for receiving one or more ratings for the user-recorded videos.

16. The computer readable media of claim 13 further comprising computer program code for sharing the user-recorded videos via social networking sites.

17. The computer readable media of claim 13 further comprising computer program code for receiving the user-recorded video from the user.

18. The computer readable media of claim 13 wherein the user-recorded video includes a video recording of the user performing lip-synching with an audio clip of a given one of the plurality of segments.
